(19) United States
(12) Patent Application Publication
(10) Pub. No.: US 2007/0182116 A1
(43) Pub. Date: Aug. 9, 2007

(54) MOBILITY SCOOTER

(75) Inventors: Nigel M. Davey, Veradale, WA (US); Todd E. Pollock, Spokane, WA (US); Robert L. Allen, Spokane, WA (US)

Correspondence Address: STEVE BERTONE;KIRKPATRICK & LOCKHART PRESTON GATES ELLIS LLP, 618 WEST RIVERSIDE AVENUE, SUITE 300, SPOKANE, WA, 99201-0628, US

(73) Assignee: Enhanced Mobility Systems, Inc., Spokane Valley, WA (US)

(21) Appl. No.: 11/669,855

(22) Filed: Jan. 31, 2007

Related U.S. Application Data
(60) Provisional application No. 60/763,840, filed on Jan. 31, 2006.

(51) Int. Cl. B62M 1/00

(52) U.S. Cl. 280/87.05

(57) ABSTRACT

An improved mobility scooter comprising a frame, an adjustable seat, a plurality of wheels coupled to the frame, and handlebars coupled to the frame. The handlebars can be folded downward to provide a compact configuration of the apparatus for travel, storage or other space restrictions. In another aspect, the improved mobility scooter further comprises a locking mechanism in its wheel casters, thereby providing for the selective configuration of the wheels in a fixed position with respect to the frame. In yet another aspect, a method of assisted mobility for an operator is described.

### CROSS REFERENCE TO RELATED APPLICATIONS

This application claims priority to the earlier provisional application entitled “Mobility Scooter” filed Jan. 31, 2006 and having Ser. No. 60/763,840, the disclosures of which are hereby incorporated herein by reference in their entirety.

### TECHNICAL FIELD

The present invention relates to a mobility scooter which can be used by injured, disabled or the elderly persons. More particularly, the mobility scooter comprises a collapsible handlebar mechanism for space saving purposes and a locking mechanism to lock one or more wheel casters at a selected angular position.

### BACKGROUND

Knee scooters are rapidly replacing crutches, walkers and wheelchairs as the preferred means to remain mobile and active during one's injury, rehabilitation from surgery or other disablement. Knee scooters typically provide more stability and mobility than crutches or a walker, therefore allowing more freedom, comfort and confidence to be enjoyed by the user.

Traditionally, doctors have recommended walkers and crutches when a patient is required to keep their bearing weight off a foot or leg. Unfortunately, crutches exhibit a number of requirements and restrictions, namely: (i) crutches require a patient to maintain their balance, (ii) crutches require that a patient hold up the weight of their injured leg, (iii) crutches require a patient to keep their leg in a bent position, (iv) crutches require a patient to constantly shift their weight back and forth to move forward, and (v) crutches can be difficult to maneuver on uneven or unstable terrain, (e.g. stairs, gravel). Sore or bruised body tissue, sprained and sore wrists, and the propensity for falling also typically go hand-in-hand with the use of crutches.

Doctors have traditionally also prescribed walkers to patients. As with crutches, when using a walker a patient is still required to hold up the weight of their recovering or disabled leg. Instead of swinging their body weight, a patient typically hops forward when using a walker. This hopping can place extraordinary stress on the weight bearing foot, the circulatory system of the leg, the hips, and the back.

A wheelchair is generally prescribed for patients who do not have the balance, strength or stability to use crutches or a walker. However, medical studies have demonstrated that a wheelchair can contribute to a deterioration of cardiovascular health, strength and overall energy. Doctors and patients alike recognize that the earlier a patient is able to be mobile and stay out of a wheelchair—the more progress a patient makes toward his/her recovery. Therefore, a knee scooter can be an advantageous substitute for a wheelchair, as a wheelchair typically requires the assistance of others while a knee scooter can be operated autonomously. It is also observed that knee scooters are neither as restrictive nor cumbersome as wheelchairs.

While the benefits of knee scooters are a significant improvement over crutches, walkers and wheelchairs, prior art knee scooters do exhibit several shortcomings. First, such knee scooters typically occupy a significantly larger physical space than crutches and may not collapse into a smaller physical size for storage. As such, such prior art knee strollers can become cumbersome to store, particularly those with a wide footprint and tall handlebars. Yet another shortcoming in such devices is directed at the wheel caster, or structures that hold the wheels to the frame of the knee scooter. Some products found in the prior art have rigid brackets which do not facilitate desirable turning qualities for the knee scooter. Where the front wheels do not turn, it can become particularly challenging for the disabled or elderly to turn the knee scooter within a short diameter, such as a hallway, without lifting either the front or rear of the knee scooter. Since a patient typically bears a significant amount of weight upon the knee scooter, it can be difficult to lift the end of the scooter to accommodate such a turn. Conversely, other knee strollers have a plurality of freely turning caster that connect the wheels to the frame of the knee scooter. At times, these wheels can become unstable around small holes, crevasses or other depressions on the ground as the wheel will freely turn to sink into such a depression. Moreover, a knee scooter configured with freely turning caster creates an unstable environment where the knee scooter is utilized on a slope or varying terrain. This instability is compounded further where freely turning casters are configured both on the front and rear of the knee scooter.

Given the above shortcomings exhibited by the prior art of knee scooters, a more compact solution rendering increased stability of its wheels is needed.

### SUMMARY

Mobility scooter embodiments of the present invention address the above shortcomings experienced in prior art knee scooters and other mobility devices.

In one aspect, the improved mobility scooter comprises a frame capable of supporting the weight of an operator across its length, an adjustable seat coupled to the frame thereby providing a comfortable location for the operator to place a leg, a plurality of wheels coupled to the frame, and handlebars coupled to the frame, thereby providing for the selective steering of the frame by the operator. In various preferred embodiments, the handlebars can be folded downward to provide a compact configuration of the apparatus for travel, storage or other space restrictions.

In the preferred embodiment described herein, a handlebar tilting mechanism comprises a bottom plate and a tilt plate hingedly coupled together, thereby coupling the frame to the handlebars. Preferably, the handlebar tilting mechanism further comprises a pair of lateral arms of the bottom plate engaging a pair of notches of the tilt plate, thereby providing for a selectively secure coupling between the bottom plate and the tilt plate, (and thereby further providing a selective configuration of the frame and the handlebars member). A stop member prevents the handlebars from dropping to the ground when the handlebars are configured in a compact configuration.

In another aspect, the improved mobility scooter further comprises a locking mechanism in its wheel casters, thereby providing for the selective configuration of the wheels in a fixed position with respect to the frame. As described herein, such a locking mechanism can be made using a sprocket, a notch, a spring plate and a release, together providing selective configuration of locking a vertical axle of the wheel casters to the frame in a fixed position. In certain applications, it is also desirable to configure an improved mobility scooter wherein the locking mechanism allows the one or more of the front wheels to be locked in a straight ahead forward position only.

In yet another aspect, the above described embodiments of the present invention comprise brakes to arrest the movement of the improved mobility scooter by the operator.

In yet another aspect, a method of assisted mobility for an operator is described, variously comprising the steps of: (i) providing a mobility scooter, (ii) placing the leg of the operator on the seat and shifting a portion of the operator's weight onto the mobility scooter, (iii) locking one or more wheels, and (iv) pushing against the ground with an opposite leg of the operator, such that the operator and the mobility scooter move forward together.

### BRIEF DESCRIPTION OF THE DRAWINGS

In order that the invention may be clearly understood and readily carried into effect, a preferred embodiment of the invention will now be described, by way of example only, with reference to the accompanying drawings wherein:

FIG. 1 is an isometric view of a mobility scooter according to the present invention with a handlebars member in a raised position;

FIG. 2 is an isometric view of the mobility scooter shown in FIG. 1 with a handlebars member in a compact configuration;

FIG. 3 is a top isometric view of the mobility scooter shown in FIG. 1 with a handlebars member in a compact configuration;

FIG. 4 is a lower isometric view of a tilting mechanism of the mobility scooter shown in FIG. 2.

FIG. 5 is an upper isometric view of the tilting mechanism of the mobility scooter shown in FIG. 4;

FIG. 6 is a bottom view of a wheel lock mechanism used with the present invention with the wheel removed;

FIG. 7 is a partially-exploded, isometric view of the wheel lock assembly shown in FIG. 6; and

FIG. 8 is an isometric view of a caster used with the present invention and a partially-exploded, isometric view of the wheel lock mechanism shown in FIG. 6.

### DETAILED DESCRIPTION OF PREFERRED EMBODIMENTS

In the following description, for the purposes of explanation, specific details are set forth in order to provide a thorough understanding of the invention. However, it will be apparent that the invention can be practiced without these specific details. In other instances, well-known structures and devices are depicted in block diagram form in order to avoid unnecessary obscuring of the invention. Section titles and references appearing within the following paragraphs are intended for the convenience of the reader and should not be interpreted to restrict the scope of the information presented at any given location.

Various aspects and features of example embodiments of the invention are described in more detail hereinafter in the following sections: (i) Definitions, (ii) Functional Overview, (iii) Preferred Embodiments and (vi) Conclusion.

### DEFINITIONS

Before addressing details of embodiments described below, some terms are defined or clarified. As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

As used herein, the term “compact”, “folding” or “collapsible” may be used to describe embodiments of the present invention having the capability of reducing its physical dimensions by manipulating certain components of the apparatus thereof.

As used herein, the terms “injured”, “disabled” or “disability” refer generally to users that are injured, recovering from an injury, disabled, handicapped, physically challenged or otherwise desiring of an apparatus to effect locomotion of their body. Such a characterization may be voluntary or involuntary. For example, an elderly or other person desiring such an apparatus, despite their ability to effect locomotion of his/her body without such an apparatus, may also be generally characterized under these terms for the sake of technical disclosure and claims of the present invention.

As used herein, the terms “user”, “patient” and “operator” may be variously and interchangeably used and intend to refer to an operator, a patient, a person assisting a patient, a healthcare professional or another person using or otherwise demonstrating the embodiment of the present invention. A user is not limited to representing a single person, and can be any number of persons utilizing the apparatus or performing the methods disclosed herein.

### FUNCTIONAL OVERVIEW

Similar to the knee stroller as described in the above section, preferred embodiments of the present invention comprise of a wheeled apparatus that provides stability to a patient or other user. Such preferred embodiments, hereinafter referred to as a “mobility scooter”, generally comprise of a frame having a set of handlebars, a cushioned platform to rest an leg, and a plurality of wheels to afford locomotion of the body and device together.

Generally speaking, a mobility scooter is best prescribed to those patients who have injuries below the knee. Such injuries could include fractured bones, sprained or torn soft tissues, ulcers or lacerations, infections, dislocations or other maladies of the lower leg.

The mobility stroller is also helpful for patients that do not necessarily exhibit a lower leg disability, but instead desire additional stability for their locomotion. Examples of such circumstances are patients with amputations, patients with arthritis, or elderly patients with diminished strength.

To use a mobility scooter, a user places the knee of his/her injured leg on the cushioned platform of the apparatus and places at least one hand on the handlebars. To move forward, the user shifts his/her weight to the non-injured leg and pushes against the ground with the foot to move the apparatus and body forward together. When the user desires to turn, the user simply turns the handlebars to the desired direction and likewise moves the body and apparatus forward together.

Having provided a functional overview of various applications, specific embodiments and their respective components and characteristics shall now be discussed in conjunction with the attached figures.

### PREFERRED EMBODIMENTS

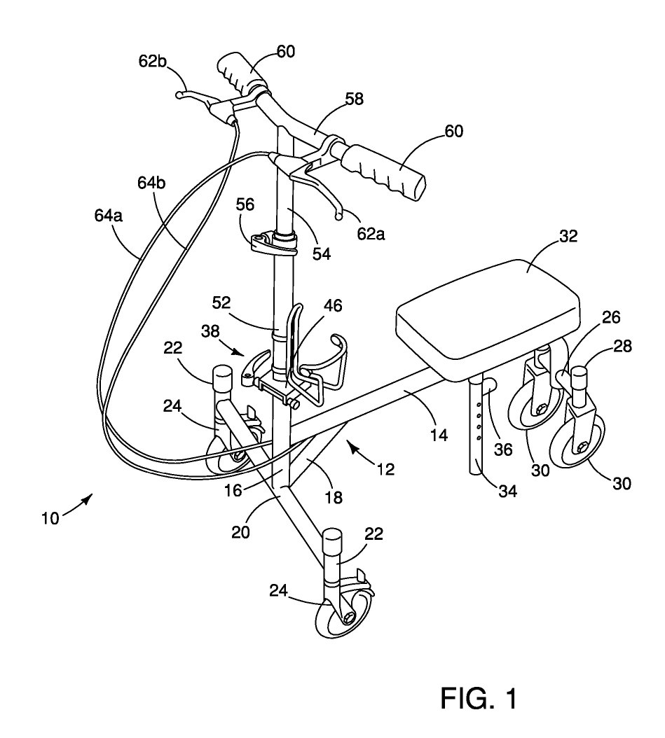

A mobility scooter 10, according to the present invention, is shown in FIG. 1. The mobility scooter 10 comprises a frame 12. The frame 12 provides a physical structure to bear the weight of a user and connect the various components of the mobility scooter 10. The frame could be of any conventional bicycle frame material, namely aluminum, titanium or other metal. For an extremely lightweight version, it is contemplated that a carbon fiber or composite version could also be constructed. The frame could be of glued, welded or bending manufacture, depending upon the desired appearance and strength.

More particularly, the frame 12 comprises a longitudinal member 14 mounted to a front upright member 16. A diagonal brace 18 is recommended to secure the longitudinal member 14 and the front upright member 16, thereby adding additional strength to the frame 12 such that it can bear the weight of a user across the span between the front and rear wheels. While the present frame 12 is shown as a tubular material, the frame 12 can also be of other shapes such as oval, rectangular or other polygonal cross-sections as well.

A laterally extending front wheel support member 20 is secured at the bottom end of the front upright member 16. At each end of the front wheel support member 20 a frontal caster post 22 is provided. A caster 24 is mounted to each frontal caster post 22. The rearward end of the longitudinal member 14 can be configured to bend downwardly and secure to a laterally extending rear wheel support member 26. A rear caster post 28 is secured at each end of the rear lateral member 26. A rear wheel 30 is mounted to each rear caster post 28. As it can be desirable in various embodiments, the structure of the frame 12, front upright member 16, caster post 22, rear lateral member 26 and rear caster post 28 can be combined into fewer structural parts, as such combinations are desirable when designing and manufacturing with certain materials such as carbon composites.

Typically, prior art knee scooters have the front upright member 16 configured significantly off center of the front wheel support member 20, such that the knee scooter is considered either a left-side or a right-side knee scooter. This configuration of the prior art is intended to keep the wheel caster 24 and wheel 30 away from the motion of the opposite (non-disabled) leg intended to provide locomotion for the body and knee scooter. However, this may result in the necessity of increasing the stance of the rear wheels 30, resulting in interference between the opposite (non-disabled) leg and the rear wheels 30.

Contrary to the prior art, it is advantageous in embodiments of the present invention to configure the upright member 16 in the center of the front wheel support member 20. In this configuration, an operator does not have to make any adjustments to the mobility scooter 10 to allow the mobility scooter 10 to be operated with either the left leg or the right leg on the seat 32.

On a related note, prior art knee scooters typically exhibit a distance between each of the rear wheels equal or substantially similar to that of the distance between each of the front wheels. In some cases, the front wheels are only slightly farther apart than the rear wheels. This configuration found in prior art knee scooters, while rather stable, poses a problem that the rear wheels can become obstruction for the opposite (non-disabled) leg during usage of the prior art scooter. In this regard, it is also advantageous in embodiments of the present invention to provide a wide front wheel support member 20 providing a wider stance of the mobility scooter 10 than that evidence by the prior art. Such a configuration allows the rear wheels 30 to be closer together while preserving stability of the mobility scooter 10. Since the rear wheels 30 are closer together, the rear wheels 30 are kept away from the motion of the opposite (non-disabled) leg, resulting in ease of use and increased safety.

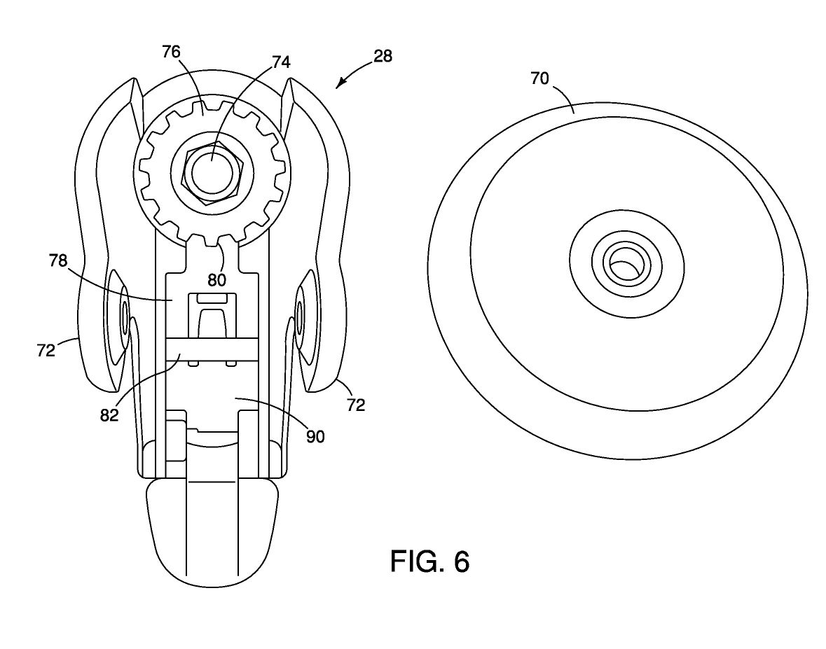

In preferred embodiments of the present invention, at least one of the front casters 24 are provided with a locking mechanism for locking the front wheel 30 at a selected angular orientation. A locking mechanism and caster according to the present invention is illustrated in various views in FIGS. 6 through 8. Such a style caster can be utilized in either the front or rear wheels of a mobility scooter, (although in the present disclosure such casters 24 are only illustrated on the front wheels).

A seat 32 is attached to a vertically extending post 34 which extends through a hole (not shown) provided in the longitudinal member 14 of the frame 12. A frictional clamp 36 is mounted to the longitudinal member 14 for clamping engagement with the vertical post 34, whereby, the seat 32 can be adjusted in height. When the desired height is set, the clamp 36 can be used to clamp the vertical post in the selected position in a conventional manner. While the illustrated and described preferred embodiment utilizes a conventional seat post mechanism, other adjustment means for securing the seat to the frame at a desired height are also contemplated, (such as cross-bolts, pins and holes, suspension systems or other seat apparatus designs).

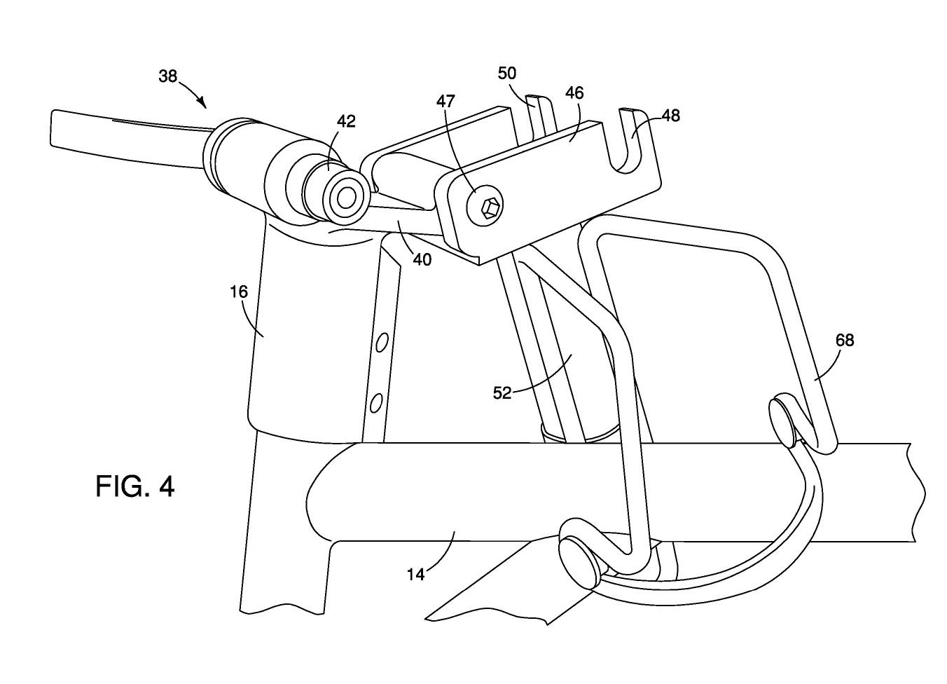

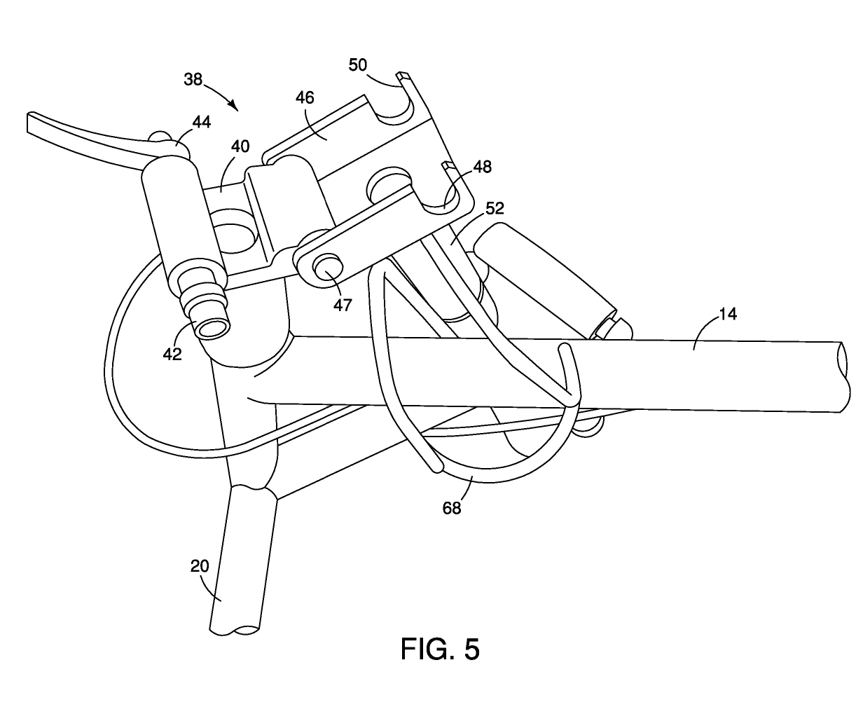

A handlebar tilting mechanism 38 is mounted to an upper end of the front upright member 16, as further detailed in FIGS. 4 and 5. The handlebar tilting mechanism 38 includes a bottom plate 40 having a pair of lateral arms 42 and 44 extending in opposite directions. The bottom plate 40 is mounted to front upright member 16. A tilt plate 46 is hingedly mounted to bottom plate 40 at position 47. The tilt plate 46 is provided with a pair of notches 48 and 50 which are sized to receive lateral arms 42 and 44 respectively when tilt plate 46 is rotated over bottom plate 40. While a hinge is detailed in the preferred embodiment illustrated, the tilting mechanism 38 can also be constructed of other quick-release or swivel means. In preferred embodiments, a combination of a push button lock and a quick release mechanism, (not shown), together, has been found to demonstrate the least amount of rattling and therefore the most secure and rigid solution for the handlebar tilting mechanism.

Returning to FIG. 1, a tubular member 52 is mounted to tilt plate 46 as shown in FIG. 1. A handlebar post 54 is slidably received by tubular member 52. A frictional clamp 56 is mounted to the tubular member 52 for clamp engagement with the handlebar post 54, whereby the handlebar post 54 can be adjusted in height with respect to tubular member 52.

A handle bar member 58 is secured to a distal end of handlebar post 54 and extends in a lateral direction. Preferably, handle bar grips 60 are provided at each end of the handle bar member 58. The handle bar member 58 is preferably configured to have an ergonomic shape and is constructed to angle rearwardly and downwardly as shown in FIG. 1.

Conventional left and right brake levers 62a and 62b are attached to the handle bar member 58 adjacent the grips 60 as shown in FIG. 1. An first actuator cable (not shown) is positioned within a flexible tubular cover 64a. A second actuator cable (not shown) is positioned with a flexible tubular cover 64b. The actuator cable within tubular cover 64a is connected to brake lever 62a and the actuator cable within tubular cover 64b is connected to brake lever 62b. With this arrangement the actuator cables can be drawn through the tubular covers whenever the brake levers 62a and 62b are moved toward the grips 60. The brake levers 62a and 62b are preferably spring-loaded and are resiliently biased to a position away from grips 60.

In preferred embodiments, the brake levers 62a and 62b incorporate a brake locking mechanism, such as a button, which provide the capability to lock the brake members 66a and 66b into a locked position. Such a brake locking mechanism provides a convenient and stable configuration of the mobility scooter for transferring an operator's leg on or off the mobility scooter's seat 32.

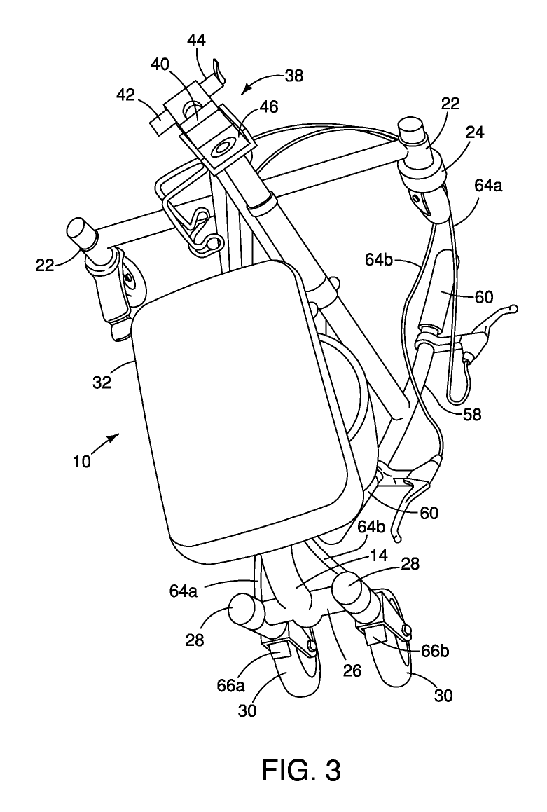

As illustrated in FIG. 3, the other ends of the actuator cables 64a and 64b are connected to conventional brake members 66a and 66b. The brake members 66a and 66b are mounted to the rear caster post 28 of a respective rear wheel 30. When a respective brake lever 62a or 62b is moved toward the grip 60 the respective actuator cable (not shown) inside tubular flexible covers 64a or 64b is retracted causing a brake member 66a or 66b to frictionally engage a rear wheel 30.

Briefly returning to FIG. 1, in preferred embodiments a stop member 68 is mounted to the tubular member 52, although stop member 68 can also be mounted to tilt plate 46 or other structure in close proximity to tilt plate 46. In the depicted figures, stop member 68 can also function as a conventional bottle holder.

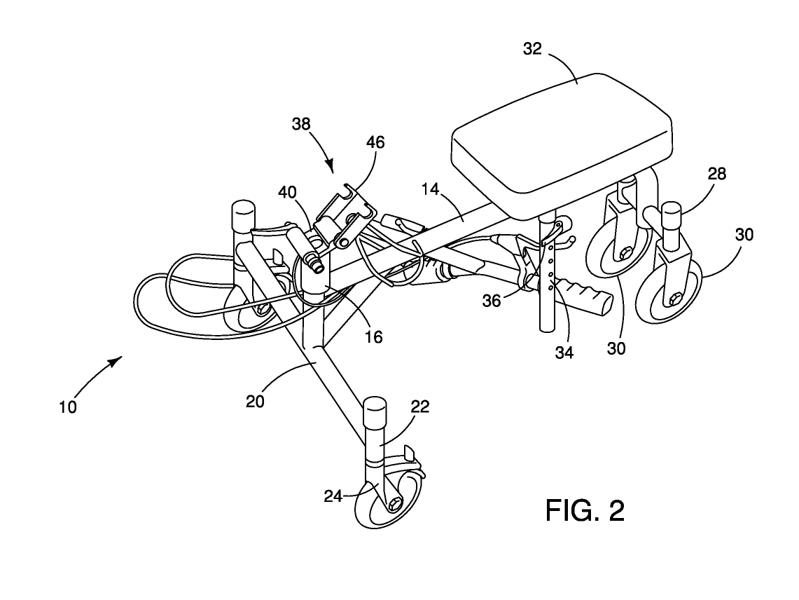

As shown in FIGS. 2, 3, 4 and 5, when the handle bar member 58 is tilted downwardly about the hinge at 47 the stop member 68 engages the longitudinal member 14 of the frame 12 so that the handlebar member 58 does not drop to the ground. While the present disclosure illustrates a collapsible mobility scooter whereby the handlebar member 58 drops horizontally, other embodiments are contemplated wherein the handlebar member can fold into multiple segments, or swivel in a method different than that depicted in the figures.

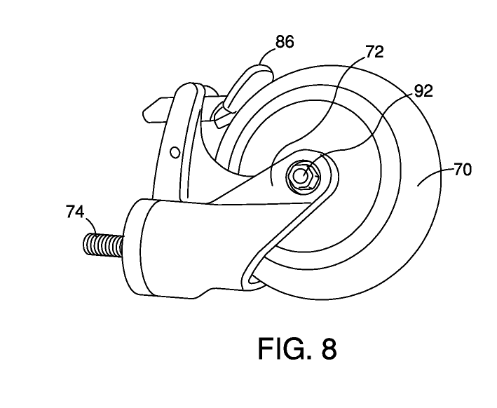

As illustrated in FIG. 8, the caster 28 includes a wheel 70 mounted within a bracket 72 by a horizontal axle 92, that engages bracket 72 at each of its ends and passes through the hole in the center of wheel 70.

Turning to FIG. 6, the bracket 72 is rotatably mounted on a vertical axle 74. The vertical axle 74 is threaded at one end for threadably mounting to the frontal caster post 22. A sprocket 76 is fixedly secured to an end of vertical axle 74. A spring plate 78 is provided which has a notch 80 at one end for engaging a tooth of sprocket 76. The spring plate 78 is typically constructed of a resilient material such as spring steel.

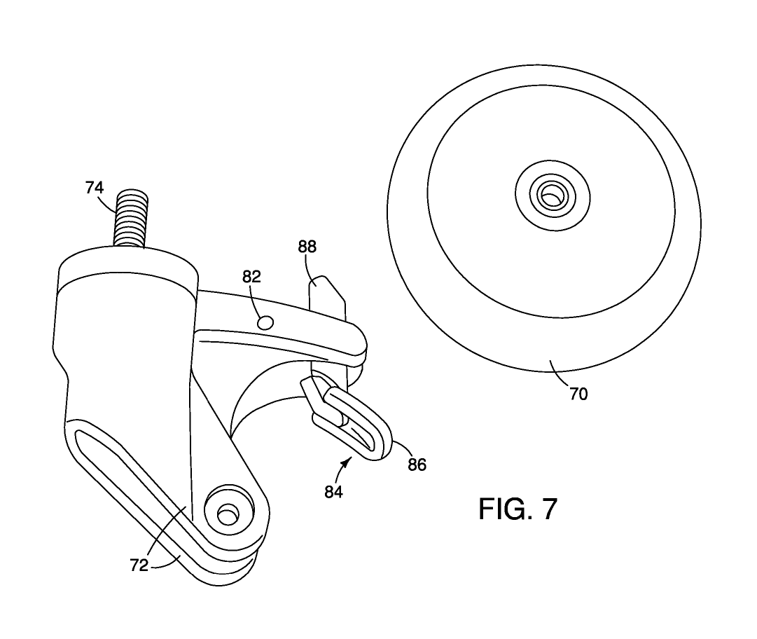

As illustrated in FIG. 7, a bar 82 extends beneath the spring plate 78 and its ends are attached to the bracket 72. In this manner, the spring plate 78 can be slightly rotated about the bar 82.

A foot operated off-center arm 84 is pivotally connected to the bracket 72. The arm 84 is moveable from an off-center locked position when an end 86 of the arm 84 is depressed downwardly. When it is desired to release the arm 84, the opposite end 88 is moved forwardly thereby rotating the arm 84 and releasing the arm 84 from the over-center condition.

The spring plate 78 has a tab 90 at an end opposite the notch 80. When the arm 84 is positioned in the over-center locked position the end 86 bends the tab 90 against the bias of spring plate 78 downwardly causing the notch 80 to move upwardly and engage a tooth of the sprocket 76. When the end 88 of the arm 84 is moved forwardly, the tab 90 is released from the end 86 and the top 90 resiliently moves upwardly causing the notch 80 to disengage from the sprocket 76.

Where desired, sprocket 76 can also be configured to have significantly fewer teeth, thereby restricting the ability to lock the wheel only into certain orientations. For example, one such application would be a sprocket 76 having only a few teeth, and thereby allowing the wheel 30 to lock into the straight ahead forward position. In other embodiments, (not shown), it can be desirable to only allow a wheel 30 to lock only into a straight forward or rearward positions, thereby aligning the forward or rearward track of a wheel 30 to be parallel with the central axis of the longitudinal member 14. In such embodiments, such a feature makes it easy for an operator to easily manipulate and lock the wheel into the forward or rearward direction without the risk of having the wheel inadvertently locked into a position slightly off the straight forward or rearward position.

As illustrated in FIGS. 1 and 7, in many applications a vertical axle 74 comprises a threaded bolt which engages a frontal caster post 22. While this attachment means is cost-effective and sufficient for a wheel caster 24 that either does not have a locking mechanism or only contains a locking mechanism that provides a locking feature across a broad variety of wheel angles, such an attachment means can become unreliable and difficult to install where a locking mechanism of the wheel caster provides only a locking feature in the straight forward or rearward positions. This is due to the fact that the vertical axle 74 has a propensity of being installed in an orientation that does not perfectly align with the central axis of the frame 12. Likewise, if the vertical axle 74 is installed too tight, or loosens over time, the sprocket 76 engaged to the vertical axle 74 becomes misaligned with the central axis of the frame 12, and therefore the track of a wheel 30 also becomes misaligned with the central axis of the frame 12. To remedy this potential problem, it is preferred that an alternate means of connecting the wheel caster 24 to the caster post 22 be implemented in mobility scooter embodiments where a locking mechanism of the wheel caster 24 only allows locking in straight forward or rearward positions. One such attachment means (not shown) is a bayonet fitting with a cross bolt and grub screws. Such an attachment means allows a wheel caster 24 to be engaged into the caster post 22, such that the wheel caster 24 is automatically aligned in its locked position with the central axis of the frame 12.

To prepare the mobility scooter for operation, the handlebar member 58 is tilted upwardly to the usable position as shown in FIG. 1. When this occurs, the tilt plate 46 is rotated over the bottom plate 40 and the notches 48 and 50 receive the lateral arms 42 and 44 thereby locking the handlebar in an upright position.

The frictional clamp 36 is adjusted to adjust the vertical height of the handlebar 58 and the frictional clamp 36 is used to adjust the vertical height of the seat 32.

The mobility scooter is then operated in a conventional manner and if necessary the hand brake levers 62a and 62b can be actuated to arrest the locomotion of the scooter. When the scooter is on a slightly inclined surface the scooter would have a tendency to roll downhill. In this situation, the end 88 of the arm 84 attached to a caster 24 can be depressed by using the foot to lock the front caster 24 in a selected angular position. The scooter will continue to roll but the caster will not rotate on the vertical axle 74.

### CONCLUSION

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. For example, the device could be adapted slightly for use in other assisted mobility applications, such as stride assessment and gait training.

Unless otherwise indicated, all numbers expressing quantities of ingredients, properties such as molecular weight, reaction conditions, and so forth used in the specification and claims are to be understood as being modified in all instances by the term “about” or “approximately.” Accordingly, unless indicated to the contrary, the numerical parameters set forth in the following specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. It is anticipated that one or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Preferred embodiments of this invention are described herein, including the best mode known to the inventors for carrying out the invention. Of course, variations on those preferred embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references may have been made to patents and printed publications throughout this specification. Each of the above cited references and printed publications, if any, are herein individually incorporated by reference in their entirety.

In closing, it is to be understood that the embodiments of the invention disclosed herein are illustrative of the principles of the present invention. Other modifications that can be employed are within the scope of the invention. Thus, by way of example, but not of limitation, alternative configurations of the present invention can be utilized in accordance with the teachings herein. Accordingly, the present invention is not limited to that precisely as shown and described.

What is claimed is:

1. An improved mobility scooter, comprising:
a frame capable of supporting the weight of an operator across its length;
a seat coupled to the frame, thereby providing a comfortable location for the operator to place a leg, wherein the height of the seat is adjustable with respect to the frame;
a plurality of front wheels coupled to the frame and a plurality of rear wheels coupled to the frame, together providing a means for the frame to move across a surface; and,
a handlebars member coupled to the frame, thereby providing for the selective steering of the frame by the operator, wherein the handlebars member can be selectively configured to reduce the physical space occupied by the improved mobility scooter.

2. The improved mobility scooter of claim 1, wherein a vertical distance between the handlebars member and the frame is adjustable with respect to the frame when configured in a raised configuration.

3. The improved mobility scooter of claim 1, further comprising a front wheel support member to couple the front wheels to the frame, and a front upright member to couple the handlebars member to the frame, wherein the front upright member is coupled to the front wheel support member approximately in the center of the front wheel support member.

4. The improved mobility scooter of claim 1, wherein the distance between each the front wheels is at least twice the distance between each of the rear wheels.

5. The improved mobility scooter of claim 1, further comprising a handlebar tilting mechanism, thereby coupling the frame to the handlebars member.

6. The improved mobility scooter of claim 4, wherein the handlebar tilting mechanism comprises a bottom plate and a tilt plate hingedly coupled together, thereby coupling the frame to the handlebars member.

7. The improved mobility scooter of claim 6, wherein the handlebar tilting mechanism further comprises a pair of lateral arms of the bottom plate engaging a pair of notches of the tilt plate, thereby providing a selectively secure coupling between the bottom plate and the tilt plate, thereby providing a selective configuration of the frame and the handlebars member.

8. The improved mobility scooter of claim 1, wherein the mobility scooter further comprises a stop member to prevent the handlebar member from dropping to the ground when the handlebars member is configured in a compact configuration.

9. An improved mobility scooter, comprising:
a frame capable of supporting the weight of an operator across its length;
a seat coupled to the frame, thereby providing a comfortable location for the operator to place a leg, wherein the height of the seat is adjustable with respect to the frame;
a plurality of front wheels coupled to the frame and a plurality of rear wheels coupled to the frame, together providing a means for the frame to move across a surface; and,
one or more wheel casters coupling one or more of the front wheels to the frame, the one or more wheel casters having a locking mechanism capable of selectively locking one or more of the front wheels in a specific orientation with respect to the frame.

10. The improved mobility scooter of claim 9, wherein the locking mechanism allows the one or more front wheels to be locked in a straight ahead forward position only.

11. The improved mobility scooter of claim 9, wherein the attachment means coupling the one or more wheel casters to the frame is a bayonet fitting with a cross bolt and grub screws.

12. The improved mobility scooter of claim 9, wherein the locking mechanism further comprises a sprocket, a notch, a spring plate and a release, together providing selective configuration of locking a vertical axle of the one or more wheel casters to the frame in a fixed position.

13. The improved mobility scooter of claim 9, further comprising a handlebars member coupled to the frame, thereby providing for the selective steering of the frame by the operator, wherein the handlebars member can be selectively configured to reduce the physical space occupied by the improved mobility scooter, and wherein the distance between each the front wheels is at least twice the distance between each of the rear wheels.

14. The improved mobility scooter of claim 13, further comprising a handlebar tilting mechanism, thereby coupling the frame to the handlebars member.

15. The improved mobility scooter of claim 13, further comprising a handlebar tilting mechanism, wherein the handlebar tilting mechanism comprises a bottom plate and a tilt plate hingedly coupled together, thereby coupling the frame to the handlebars member, and wherein the handlebar tilting mechanism further comprises a pair of lateral arms of the bottom plate engaging a pair of notches of the tilt plate, thereby providing a selectively secure coupling between the bottom plate and the tilt plate, thereby providing a selective configuration of the frame and the handlebars member.

16. The improved mobility scooter of claim 13, further comprising one or more brake levers and one or more brake members providing the ability to arrest the movement of the improved mobility scooter by the operator.

17. The improved mobility scooter of claim 13, further comprising:
a handlebar tilting mechanism, wherein the handlebar tilting mechanism comprises a bottom plate and a tilt plate hingedly coupled together, thereby coupling the frame to the handlebars member, and wherein the handlebar tilting mechanism further comprises a pair of lateral arms of the bottom plate engaging a pair of notches of the tilt plate, thereby providing a selectively secure coupling between the bottom plate and the tilt plate, thereby providing a selective configuration of the frame and the handlebars member;
a stop member preventing the handlebars member from dropping to the ground if the mobility scooter is configured in a compact configuration;
one or more brake levers and one or more brake members providing the ability to arrest the movement of the improved mobility scooter by the operator;
wherein the distance between each the front wheels is at least twice the distance between each of the rear wheels;
wherein a vertical distance between the handlebars member and the frame is adjustable with respect to the frame when configured in a raised configuration
wherein the locking mechanism further comprises a sprocket, a notch, a spring plate and a release, together providing selective configuration of locking a vertical axle of the one or more wheel casters to the frame in a fixed position;
wherein the locking mechanism allows the one or more front wheels to be locked in a straight ahead forward position only; and,
wherein the attachment means coupling the one or more wheel casters to the frame is a bayonet fitting with a cross bolt and grub screws.

18. A method of assisted mobility for an operator, comprising the steps of: providing a mobility scooter, the mobility scooter comprising:
a frame capable of supporting the weight of an operator across its length;
a seat coupled to the frame, thereby providing a comfortable location for
the operator to place a leg;
a plurality of wheels coupled to the frame and a plurality of rear wheels coupled to the frame, together providing a means for the frame to move across a surface;
a handlebars member coupled to the frame, thereby providing for the selective steering of the frame by the operator; and,
one or more wheel casters coupling one or more of the wheels to the frame, the one or more wheel caster having a locking mechanism capable of selectively locking the wheel in a specific orientation with respect to the frame; and,
placing the leg of the operator on the seat and shifting a portion of the operator's weight onto the mobility scooter thereon.

19. The method of claim 18, further comprising the step of locking the one or more wheels with the locking mechanism.

20. The method of claim 18, further comprising the step of locking the one or more wheels with the locking mechanism in a straight ahead forward position.

21. The method of claim 18, further comprising the step of pushing against the ground with an opposite leg of the operator, such that the operator and the mobility scooter move forward together.
